(19) United States
(12) Patent Application Publication
(10) Pub. No.: US 2002/0073233 A1
(43) Pub. Date: Jun. 13, 2002

(54) Systems and methods of accessing network resources

(76) Inventors: William Gross, Pasadena, CA (US); Lee Zachary Hasiuk, Rochester, NY (US); Fernando Pedro Echeverria, Penalolen (CL)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/863,060

(22) Filed: May 22, 2001

Related U.S. Application Data
(60) Provisional application No. 60/206,116, filed on May 22, 2000.
(60) Provisional application No. 60/273,273, filed on Mar. 2, 2001.

(51) Int. Cl. G06F 15/16

(52) U.S. Cl. 709/245; 709/206; 709/203

(57) ABSTRACT

The present invention provides methods and systems for utilizing non-ICANN compliant top-level domain (TLD) names. In one embodiment of the present invention, client-based address conversion software is used to intercept a requested Internet address having a non-ICANN compliant TLD. The address conversion software then appends an extension, including at least an ICANN-compliant TLD, to the end of an Internet address. Further, one embodiment of the present invention is operable with proxy servers. In addition, an email address conversion method and system is provided that intercepts emails whose recipient address includes a non-standard TLD and appends at least a standard TLD thereto. When an email is received, including a sender's email address with a domain having a predetermined ICANN compliant TLD, at least the predetermined TLD is stripped from the sender's email address for display.

### PRIORITY CLAIM

This application claims the benefit of U.S. Provisional Application No. 60/206,116, filed May 22, 2000 and U.S. Provisional Application No. 60/273,273, filed Mar. 2, 2001, which are incorporated herein in their entirety.

### BACKGROUND OF THE INVENTION

1. Field of the Invention

The present invention is related to top-level domain names, and in particular to methods and systems for creating non-ICANN compliant top-level domain names.

2. Description of the Related Art

The Internet is accessible using a client computer or the like executing a web browser and using a communication connection medium. Communication may be established through a normal phone line using a modem, a DSL line, a cable modem, a Network Interface Card (NIC), a Local Area Network (LAN), or the like. Through any of these forms of communication, the computer accesses an Internet Service Provider (ISP). Smaller ISPs will then connect to larger ISPs. As a result, every computer on the Internet is “connected” to every other computer on the Internet.

Once connected or online, a user utilizes the web browser to access and view websites by entering an Internet address in the form of a domain name, such as www.domain-name1.com, for example, or a Uniform Resource Locator (URL), in the form of http://www.domain-name1.com/index.htm. Thus, for instance, the Internet address for the White House's website is www.whitehouse.gov.

The use of such human understandable domain names makes it easier for users to remember Internet addresses, however these domain names need to be translated into IP addresses. An IP address is a 32-bit number, normally expressed as 4 octets in a dotted decimal number. A typical IP address may be in form of 216.27.61.137.

The browser extracts the Internet address, www.domain-name1.com, from the URL, mentioned above, and transmits a look-up request, including the extracted address, to a Domain Name System server (DNS server). The Domain Name System gives each computer on the Internet an IP address corresponding to a domain name. The DNS servers include databases that map domain names to IP addresses. In response to the look-up request, the DNS server returns the IP address corresponding to the domain name to the browser. The browser then uses the IP address to access the corresponding computer. It may take a number of servers to locate the corresponding IP address. For example, a first name server for the “com” top-level domain stores the IP address for a second name server that stores the host names. A separate query is then made by the first name server to the second name server for the actual IP address for domain-namel's server machine.

A database including each domain name and the numeric IP address of the server associated with that domain name is maintained. The domain name for the Internet address www.domain-name1.com, for example, is “domain-name1”. The phrase “Top-Level Domain” (TLD) refers to the suffix attached to the Internet domain name. Thus, for example, the “com” suffix is considered a top-level domain name. Each TLD name has its own database of domain names.

The top-level domain names are defined and approved by ICANN (Internet Corporation for Assigned Names and Numbers). ICANN is a private corporation with responsibility for IP address space allocation, protocol parameter assignment, domain name system management, and root server system management functions. Disadvantageously, there are a very limited number of ICANN compliant top-level domains. As a result, this limits the number of ICANN compliant domain names available to users. Further, the rarity of top-level domains make it more difficult to organize access to the Internet. The ICANN compliant TLD names include “.com”, “.net”, “org”, “.gov”, “.mil”, “.edu”, and two letter country codes, such as “.tv”. ICANN has also recently approved the following new top-level domain names, “.biz”, “.info”, “.name”, “.pro”, “.aero”, “.museum”, and “.coop”. Other standard TLDs include “.arpa”, and “.int”. The “.com” extension is intended for commercial businesses, “.net” is intended for network organizations, “.edu” is intended for schools or a place of higher learning, “.org” is intended for organizations, “.gov” is intended for government sites. The new TLD names are intended to be used as follows, “.biz” is intended for business, “.info” is for unrestricted use, “.name” is intended for individuals, “.pro” is intended for professionals (eg. accountants, lawyers, physicians, and engineers), “.aero” is intended for the air-transport industry, “.museum” is intended for museums, and “.coop” is intended for cooperatives.

Domain names may be duplicated between the different top-level domain names. For example, a user may view two completely different websites by entering www.domain-name1.com and www.domain-name1.net in a browser window.

As previously discussed, users typically enter an Internet address of the site they are looking for into an address line of their browsers (eg. www.domain-name1.com) or otherwise select the Internet address. The browser then works with the computer's operating system to contact a domain name system server, which translates the alphanumeric domain name into a numeric IP address, so that the request can be routed to the appropriate server on the Internet. The request for “www.domainname1.com”, by way of example, might be translated to 183.52.148.72. The request for that specific webpage can then be routed to domain-namel's server.

### SUMMARY OF THE INVENTION

The present invention is directed to methods and systems used to provide top-level domain names over and above those specified by the Internet Corporation for Assigned Names and Numbers (ICANN) or other authority authorized to approve standardized top-level domain names.

In accordance with one embodiment of the present invention, address translation or mapping software is used to alter Internet addresses to thereby enable browsers and other connectivity devices or systems to access and/or utilize top-level domains that are not yet activated or approved by ICANN. The interception and modification of the Internet addresses utilizing the non-ICANN recognized top-level domain (TLD) names can be performed using different embodiments of processes and systems in accordance with the present invention.

In one embodiment, the process of managing non-ICANN compliant TLDs is performed by first defining a series of domain names that do not exist in the Internet top-level domain name infrastructure defined by ICANN. Some or all of these newly defined domain names may be sold to website operators, consumers, or otherwise distributed. In one embodiment, the domain names are optionally required to be RFC1035 compliant, in that they are restricted to the RFC1035 defined character set, including characters selected from the set of the letters A-Z in upper and lower case, the numbers 0-9, and a hyphen “-”. Thus, the example domain names used in the following description utilize RFC1035 compliant characters.

The address translation software is correspondingly distributed to users. The address translation software intercepts requests from a client application, such as a browser, for Internet addresses and evaluates whether the user is requesting a non-ICANN compliant top-level domain. If the request contains one of the non-ICANN compliant TLDs, the address translation software converts the request to an Internet address that is ICANN compliant. Optionally, the conversion can be restricted to those defined as part of a first set, wherein the first set is defined by the entity or company managing the processing of non-ICANN compliant TLDs.

Furthermore, the address translation software optionally converts email addresses using the non-ICANN compliant TLDs into email addresses that are recognized by the existing Internet email infrastructure.

In one embodiment, the user downloads an address translation software program to a client computer system that includes WinSock2 or equivalent service providing an interface to the Name Space Provider(s) and Layered Service Provider(s) to enable utilization of the non-ICANN compliant domain addresses, as discussed in greater detail below.

The address translation software may be downloaded or installed from a floppy disk, CD-ROM, via a network, such as the Internet, or may be pre-installed on the client computer. The downloaded address translation software intercepts non-standard address requests (those addresses that do not end in .com, net, .org, mil, an ICANN-defined two letter country code, or other ICANN specified TLDs) received from a browser or other application and adds an extension that includes a valid ICANN compliant TLD. For example, the extension “.new.net”, may be appended to the end of the requested address. The newly modified address is then submitted for resolution.

For example, a user downloads the address translation software and then, using the browser, requests a non-ICANN compliant Internet address, such as BestPrice.auction. As on conventional systems, the process begins with the browser requesting the operating system services to identify the numeric location of the requested website. In searching for the server location, the operating system utilizes a concatenation tool installed by the address translation software. The concatenation tool adds an extension, including an ICANN compliant TLD, to the website request, such as “.new.net”, translating the original request into “BestPrice.auction.new.net” and then resubmits the request to the operating system. With the added ICANN compliant extension, the operating system in conjunction with corresponding domain name system servers identifies a server that is associated with the requested website.

Users may also download or otherwise install an email translation software program that modifies email addresses including non-ICANN compliant TLDs. Optionally, the address translation software and the email translation software are downloaded together or as a single application. The email translation software operates at the sending stage of an email to add “.new.net” or other designated extension containing an ICANN compliant TLD to an email address that has a non-ICANN compliant TLD. At the receiving stage, when an email is received having an email address containing an extension, such as “.new.net” in this example, appended to the email address, the extension is stripped. The email address is then displayed to the recipient as having come from an address including the non-ICANN compliant TLD, but not including the appended extension containing the ICANN compliant TLD.

Thus, for example, on sending a message from joe@idealab.inc, where “.inc” is not an ICANN compliant TLD, the email translation software on the sending side adds or appends the ICANN compliant extension so that the return address is now joe@idealab.inc.new.net. Upon receiving the email message, the email translation software on the receiving side detects the prior process of adding the ICANN compliant extension, “.new.net”, and strips off the added extension to display the sender's email address as joe@idealab.inc.

Another embodiment provides a process for accessing the non-ICANN compliant Internet addresses through the user's ISP. This approach is performed in a manner transparent to the consumer. Advantageously, utilizing such non-ICANN compliant TLDs attracts more consumers. By way of example, the user enters or provides a browser with a non-ICANN compliant Internet address (eg. BestPrice.auction) of a website or other network resource. The browser, in communication with the operating system, sends an IP address lookup request to the ISP's domain name system server. The domain name system server then locates the IP address representing the server of the page requested. Similarly, IP addresses of email servers for email addresses using the non-ICANN compliant TLD names are located.

One aspect of the present invention is a method of accessing network resources using an Internet address having a non-ICANN compliant top-level domain (TLD) name, the method comprising: receiving from a user's client terminal data corresponding to a first Internet address utilizing only RFC 1035 compliant characters, the first Internet address including a non-ICANN compliant TLD, at a user's Internet Service Provider's (ISP) Domain Name System server (DNS server); receiving at the user's client terminal a negative response from the ISP DNS server in response to receiving the data corresponding to the first Internet address; receiving the first Internet address at an address converter system executing on the user's client terminal, wherein the address converter system appends an extension including an ICANN compliant TLD to the first Internet address, thereby creating a second Internet address; submitting the second address to the ISP DNS server to locate a corresponding IP (Internet Protocol) address; providing the corresponding IP address to a user browser; and connecting the user browser to a system corresponding to the IP address.

Another aspect of the present invention is a system for accessing network resources using resource addresses in a networked environment which requires the resource addresses to have a top-level domain (TLD) name compliant with a first standard, the system comprising: a first instruction configured to determine whether a first RFC 1035 compliant address has a non-standard TLD belonging to a first set of non-standard TLD names; a second instruction configured to append an extension, including at least a standard TLD, to the first RFC 1035 compliant address at least partly in response to the first instruction determining that the first address has a non-standard TLD belonging to the first set of non-standard TLD names; and a third instruction configured to provide the first address with the appended extension including the standard TLD to a service that will convert the first address with the extension including the appended standard TLD into an IP address.

Still another aspect of the present invention is a method of accessing network resources using an Internet address having a non-standard top-level domain (TLD), the method comprising: providing to a client system a Layered Service Provider (LSP) configured to filter Internet addresses containing non-standard TLDs and to append a corresponding extension, including at least a standard TLD, thereto; receiving at the LSP a first Internet address having a non-standard TLD, wherein the LSP determines that the first Internet address's non-standard TLD is in a first set of non-standard TLDs; upon determining that the first Internet address's non-standard TLD is in a first set of non-standard TLDs, adding an extension, including at least a predetermined standard TLD, to the first Internet address to create a modified first Internet address; and providing data corresponding to the modified first Internet address to a proxy server, so that the proxy server can provide the modified first Internet address to a domain name system server.

Yet another aspect of the present invention is a method of processing email addresses having non-standard top-level domain names, the method comprising: using a Layered Service Provider (LSP) to intercept, on a sender's client system, email having a first recipient email address with a non-standard TLD; adding, via the LSP, an extension, the extension including a standard TLD, to the recipient's first email address to generate a modified recipient email address; submitting the modified recipient email address to the sender's SMTP server; contacting a DNS server (Domain Name System server) to locate a corresponding IP address for an email server system associated with the modified recipient email address; returning the corresponding IP address to the sender's SMTP server; submitting the email to the email server system for delivery to the recipient using the corresponding IP address; and providing the email to the recipient.

Another aspect of the present invention is a method of processing email addresses having non-ICANN compliant level domain (TLD) names, the method comprising: determining on a sender's client system whether a first email address for an email being dispatched by the sender contains a non-ICANN compliant TLD name, wherein the first email address is associated with an intended email recipient; appending at least an ICANN compliant TLD to the first email address at least partly in response to determining that the email address contains a non-ICANN compliant TLD name, thereby forming a second email address; submitting the second email address to a Domain Name System server (DNS server) via an SMTP server to locate an IP address corresponding to a server associated with the second email address; locating the IP address; and using the located IP address to transmit the email so that it can be accessed by the recipient.

Still another aspect of the present invention is a system for processing an email address having a non-ICANN compliant level domain (TLD) name, the method comprising: a first instruction configured to determine whether a first email address for an email being dispatched by a sender contains a non-ICANN compliant TLD name, wherein the first email address is associated with an intended email recipient; a second instruction configured to form a second email address by appending an extension, including at least an ICANN compliant TLD, to the first email address at least partly in response to a determination by the first instruction that the first email address contains a non-ICANN compliant TLD name; and a third instruction configured to provide the second email address so that the second email address can be submitted to a Domain Name System server (DNS server) via a server system to thereby locate a corresponding IP address.

Yet another aspect of the present invention is a system for processing an email address having a non-ICANN compliant top-level domain (TLD) name, the system comprising: a first instruction configured to determine whether a first email address for a first received email contains a predetermined domain; and a second instruction configured to form a second email address by removing for display the predetermined domain.

### BRIEF DESCRIPTION OF THE DRAWINGS

FIG. 1 illustrates an example process for accessing a network resource using an Internet address containing a non-ICANN compliant TLD in accordance with one embodiment of the present invention;

FIGS. 2a-2b illustrate an example process for accessing an Internet address containing a non-ICANN compliant TLD in greater detail;

FIG. 3 illustrates an example process for sending an email where the sender's email address contains a TLD that is not recognized by ICANN;

FIG. 4 illustrates an example process for sending an email to a recipient address, wherein the recipient address includes a TLD that is not recognized by ICANN;

FIG. 5 illustrates an example architecture which can be used in accordance with an embodiment of the present invention; and

FIG. 6 illustrates an example process for requesting and viewing an Internet address containing a non-ICANN compliant TLD using a proxy server in accordance with an embodiment of the present invention.

### DETAILED DESCRIPTION OF THE PREFERRED EMBODIMENT

The present invention is directed to systems and methods for accessing network resources utilizing non-compliant top-level domain names. In particular one embodiment of the present invention provides systems and methods for intercepting an Internet address containing a non-ICANN recognized top-level domain (TLD) name and translating it to an ICANN recognized Internet address. The term ICANN, as used herein, refers to the Internet Corporation for Assigned Names and Numbers (ICANN) or other entity having the governmentally granted authority to approve or create standardized top-level domain names.

Throughout the following description, reference will be made to various implementation-specific details, including, for example, coding conventions, operating systems, document and protocol standards, email systems, Internet connectivity systems, and database records. These details are provided in order to fully set forth a preferred embodiment of the invention, and not to limit the scope of the invention. In addition, unless otherwise indicated, the functions described herein are preferably performed by executable code running on one or more computers. For example, the following discussions refers to utilizing web browsers to access the Internet using the present invention. Of course, other connectivity tools, such as FTP, Gopher, or Telnet can be used as well.

An embodiment utilizing a client-based implementation for processing non-ICANN recognized TLD names will now be described. A webpage is transmitted from a server to a client computer system. The server is optionally associated with an entity that registers, sells, and tracks non-compliant top-level domain names, termed herein, a TLD company. New.net, for example, is a well known provider of non-ICANN compliant TLDs. Currently, millions of users have the ability to resolve the non-standard TLDs offered by New.net.

Address translation software used to implement the client-based solution can be downloaded via the webpage. Embedded on the webpage is a downloadable address translation program, for example, a Java applet or ActiveX control, which may be digitally signed to ensure its authenticity and provide some measure of assurance that the author certifies that the address translation program is safe to run and that it has not been altered. Upon viewing the webpage using a client-based browser, the user may be asked by their web browser whether the embedded address translation program should be permitted to run, assuming the browser verifies that the digital signature is valid and that the contents have not been altered since the content was digitally signed.

Once the user agrees to allow the embedded address translation program to run, the embedded program verifies that the user's system contains Microsoft Winsock2 or an equivalent programming interface. Winsock, short for Windows sockets, is an Application Programming Interface (API) for developing Microsoft Windows compatible programs that can communicate with other machines via the TCP/IP protocol, or the like. Of course other operating systems and APIs can be used as well. If the user's system does contain Winsock2 or equivalent, the embedded program installs a Winsock2 Name Space Provider (NSP), also termed, in this example, New.net or a TLD NSP, to provide functionality for processing TLDs not recognized by ICANN.

WinSock2 utilizes the Windows Open Systems Architecture (WOSA) model, which separates the API from the protocol service provider. The WinSock DLL provides the standard API, and each vendor's service provider layer is installed below the standard API. The API layer communicates to a service provider via a standardized Service Provider Interface (SPI), and can multiplex between multiple service providers simultaneously. Winsock2 contains a first NSP, termed herein a default provider, and the New.net NSP is added as a second NSP. The default provider is typically installed when Transmission Control Protocol/Internet Protocol (TCP/IP) support is installed.

A Winsock2 NSP is a dynamic link library (DLL) which enables the conversion of alphanumeric names, such as www.domain-name1.com, to numeric addresses, such as 192.9.200.1, used to contact specific computers and their services. When an Internet address is entered in a web browser, or referred to by a link on an HTML document, the web browser uses Winsock2 or equivalent to perform the conversion of alphanumeric names to numeric addresses. Winsock2, in turn, utilizes installed Name Space Providers to perform the conversion using the Winsock2 Service Provider Interface (SPI). Of course, the Internet address may be provided to Winsock2 by other applications, as well as by a browser.

If the user is using Windows 3.1 or Windows 95, for example, where the Winsock2 advanced networking model is not available, then the user renames “winsock.d11” and places a DLL with a compatible API which performs filtering before calling the original Winsock DLL.

The New.net NSP, once installed as described above, is listed in the Winsock2 service's catalog of Name Space Providers in addition to the default provider. Once the New.net NSP is listed in the Winsock2 NSP catalog, an application utilized after the New.net NSP is installed has access to the New.net NSP services via Winsock2, as in the web browser example described above.

In general, NSPs perform domain name conversions by using the DNS server lookup protocol to establish a connection with the user's domain name system servers and locate IP addresses which are typically provided by a user's Internet Service Provider (ISP). Using the DNS server protocol, a NSP sends the alphanumeric address to the DNS server and receives the IP address(es), or when appropriate, receives a response that the alphanumeric address is not valid. For example, if a user requests an Internet address with a non-ICANN compliant TLD, such as www.idealab.inc, the default provider would not validate the address, unless the ISP has provisioned their DNS servers to recognize the non-ICANN compliant TLDs, as described below. However, if the non-ICANN compliant TLD is not registered with the ISP, then with the New.net NSP installed, the address will be resolved.

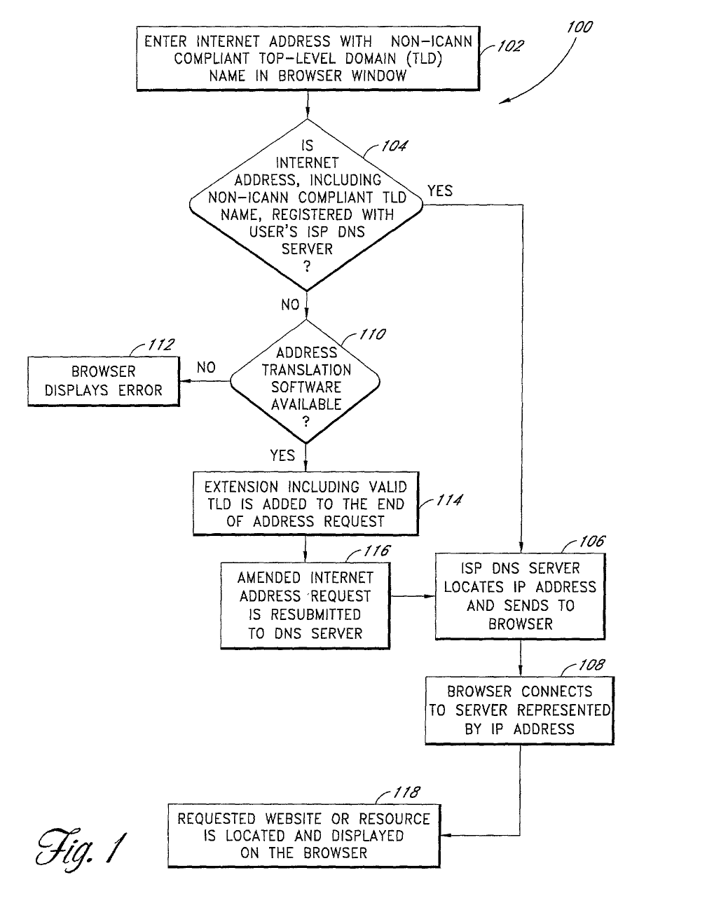

FIG. 1 illustrates an example process 100 where a non-ICANN compliant top-level domain name, in accordance with the present invention, is used within an Internet address. In one embodiment, the domain names are optionally required to be RFC1035 compliant, in that they are restricted to the RFC1035 defined character set, including characters selected from the set of the letters A-Z in upper and lower case, the numbers 0-9, and a hyphen “-”.

The user initially enters or otherwise provides an Internet address using a browser or other application at state 102. The browser attempts to verify the validity of the address by contacting the user's ISP DNS server at state 104. If the non-ICANN compliant TLD name has been pre-registered with the user's ISP DNS server, then the ISP DNS server locates and returns a corresponding IP address at state 106. Once the IP address is returned, the browser connects to the server represented by the IP address at state 108. The browser then locates and displays on the client system monitor the requested resource at state 118.

Alternatively, if the non-ICANN compliant TLD name is not registered with the user's ISP DNS server, then Winsock2 determines whether an appropriate plug-in, such as the address translation software discussed above, is available on the client system at state 110. If the address translation software is not found, the user receives a “Not Found” error from the browser. If the address translation software is available, an extension, including an ICANN compliant TLD, is added to the end of the Internet address submitted using a concatenation tool, at state 114. For example, www.idealab.inc is entered in the browser address field. The New.net NSP adds “.new.net” to the end of the Internet address, making the Internet address ICANN-compliant, and so the newly amended Internet address can be resolved by the ISP DNS server. The newly amended Internet address www.idealab.inc.new.net, is then resubmitted to the user's ISP DNS server at state 116. The DNS server verifies the validity of the amended Internet address and locates the corresponding IP address at state 108. The corresponding IP address is returned to the browser, and the website is located and displayed using the browser at state 118.

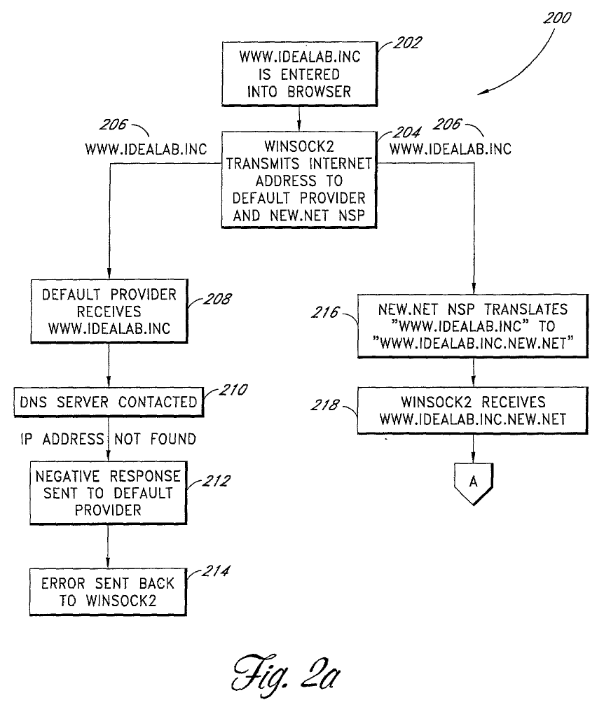

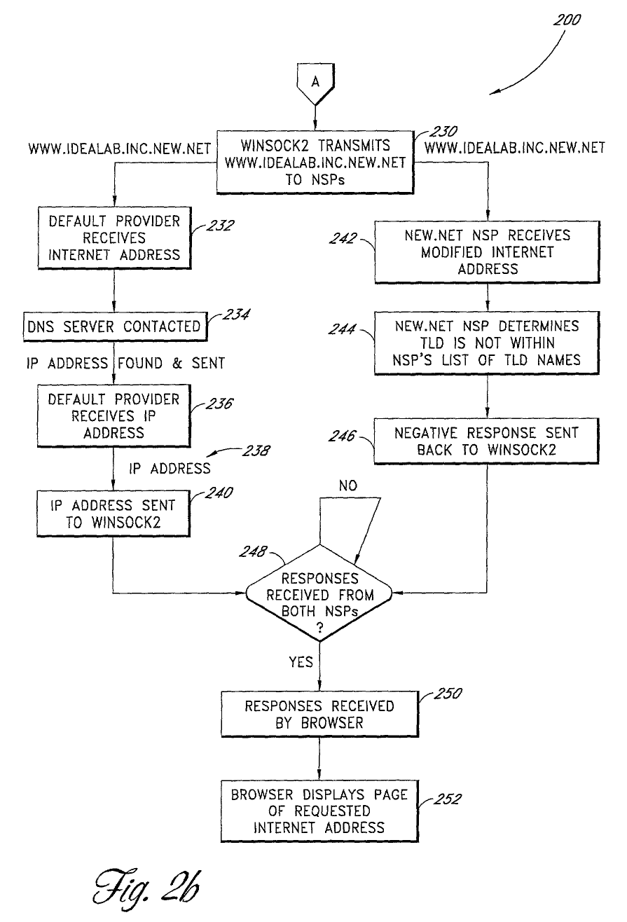

FIGS. 2a-2b illustrate an example process 200 utilizing nonstandard TLDs in greater detail. Example process 200 can also be used with other Internet addresses using different protocols, such as FTP, Gopher, Telnet, or the like. In addition, while the following description assumes a browser is being used to request network resources, the present invention can be used with other requesting applications. At state 202, a user selects or enters an Internet address into a web browser or other program which performs conversions from alphanumeric to IP addresses via the Winsock2 or equivalent interface. The default provider and the New.net NSP will then be contacted by the Winsock2 service via SPI calls at state 204. At state 216, the New.net NSP examines the Internet address 206 to determine if it meets the criterion of ending with one of several predefined endings or top-level domain names which are not normally valid in the ICANN DNS namespace. A TLD marketing company may define, register, sell, and track these predefined top-level domain names and domain names within each of the company's defined top-level domains. These non-compliant TLDs can include endings such as “.inc”, “.store”, “.kids”, “.furniture”, “.hobbies”, “.shop”, “.law”, “.family”, and so forth. New.net, for example, currently offers 20 non-standard TLDs. In one embodiment of the present invention, the New.net NSP is periodically updated by contacting a host server to update a list of the recognized or defined non-standard endings. Optionally, the New.net NSP can look for any endings, including those not defined by the TLD marketing company, which are not part of the ICANN DNS server namespace, and are thus non-standard (i.e. doesn't end in “.com”, “.org”, “.mil”, “.gov”, or the two letter ending of a country such as “.uk”, “.de”, etc).

If the Internet address 206 meets the criteria of having one of the defined non-standard endings, the New.net NSP converts the Internet address 206 at state 216 to an Internet address including a standard, ICANN compliant TLD, associated with the DNS servers of the company operating the system for managing non-standard TLDs, such as New.net. For example, a requested address, such as www.idealab.inc, would be translated internally by the New.net NSP to www.idealab.inc.new.net. Winsock2 or equivalent is then contacted by the New.net NSP and receives the translated Internet address at state 218 as if it were coming from an ordinary Winsock2 application (not a service provider).

Concurrently, the Internet address 206 is passed to the default provider at state 208, which results in the user's ISP DNS server being contacted at state 210 to locate an IP address corresponding to the server for the requested address 206. Because the Internet address 206 ends in a non-standard domain name, “.inc” in this example, a message is sent back to the default provider at state 212 indicating that a corresponding IP address was not found. The default provider then returns a negative response to Winsock2 at state 214, indicating that the DNS server does not have a corresponding IP address for the requested Internet address 206.

A secondary request is made at state 230 to the default provider NSP and the New.net NSP by Winsock2 to lookup the translated address, www.idealab.inc.new.net. When the New.net NSP receives the secondary request at state 242, the New.net NSP again verifies that the Internet address submitted does not have one of the predefined, non-standard TLDs at state 244. Because the address now has an extension including a valid TLD appended to it, the New.net NSP then responds back to Winsock2 at state 246 with a negative response. This also prevents an infinite loop from occurring.

The same secondary request is also made to the default provider. At state 232, the default provider receives the translated address, www.idealab.inc.new.net. The ISP DNS server is then contacted by the default provider at state 234. The ISP DNS server finds a corresponding IP address for the requested Internet address. The DNS server uses either a previously cached result of a valid lookup, or contacts servers higher up the chain until it reaches those controlled by the TLD company to perform a complete lookup. Once found, the ISP DNS server returns the corresponding IP address 238 back to the default provider at state 236. The default provider then returns the IP address 238 to Winsock2 at state 240.

To satisfy the original request made by the web browser in this example, Winsock2 waits for all of the NSPs contacted to provide their results at state 248. Thus, Winsock2 waits for the resolution of the original request 206, www.idealab.inc to be completed by both of the NSPs. The New.net NSP servicing the original request, in turn, waits for the resolution of its secondary request, www.idealab.inc.new.net to be completed. The IP address lookup may be delayed as the default provider uses the DNS protocol and the ISP's DNS server to complete the secondary request.

Once all results described above are gathered by Winsock2 at state 248, the original requestor, in this case the Web browser, receives the results at state 250 via the Winsock2 or equivalent programming interface. From the original lookup, Winsock2 receives confirmation that no corresponding IP address exists from the default provider search of www.idealab.inc at state 214.

From the secondary lookup, Winsock2 receives a negative response from the New.net NSP's search of www.idealab.inc.new.net at state 246, but does receive the IP address(es) 238 from the default provider's search of www.idealab.inc.new.net at state 240. The Web browser then displays the page of the requested Internet address at state 252.

Thus, process 200 allows non-standard addresses to be converted to the corresponding IP addresses of network resources, such as computers, on the Internet. This enables a user to view webpages or other content (such as FTP data), as if the non-standard address was completely standard, that is, compliant with an approved standard, such as approved by ICANN.

Another embodiment of the present invention provides for utilizing a Layered Service Provider (LSP) supplied by New.net or another TLD company to enable resolution of Internet addresses including non-ICANN compliant top-level domain names. The LSP solution is also utilized for email having email addresses including non-ICANN compliant top-level domain names. The LSP solution can be utilized with email clients resident or hosted on client computer systems, and with web-based email systems, such as Yahoo, Hotmail, or the like. The LSP is also utilized when a proxy server is used. Advantageously, use of the LSP does not necessitate two separate service provider lookups, as was described above with respect to the NSP based solution, and therefore is time efficient.

Winsock2 allows the creation of LSPs which can be stacked into chains. The LSP is installed on top of a default Transport Service Provider (TSP). One function of an LSP is to filter data, for a variety of reasons, communicated between two applications. The LSP can be used to filter, by way of example, TCP and/or UDP (User Datagram Protocol) traffic. The LSP can then be used to monitor Internet addresses containing non-ICANN compliant TLDs in accordance with one embodiment of the present invention. In particular, the LSP can be used to provide filtering of traffic through the sockets. By monitoring socket traffic, use of an application-level protocol can be detected. The LSP detects a non-compliant address in the HTTP or proxy application level protocol, and appropriately modifies the URL contained in the appropriate headers in the protocol. Thus, once a non-ICANN compliant Internet address is detected by the LSP, modification of the address by the LSP can be performed accordingly.

When a user selects or enters an Internet address into a web browser or other application, the Internet address is sent to the DNS server to locate an IP address. If the Internet address includes a predefined non-ICANN compliant TLD, then the LSP intercepts the Internet address and appends an extension including an ICANN compliant TLD, such as “.new.net”. In one embodiment of the present invention, the LSP is periodically updated by contacting a host server to update a list of the recognized or defined non-standard endings.

Similarly, if a proxy server is used, the LSP intercepts the Internet address if the Internet address includes a predefined non-ICANN compliant TLD, as described above. A proxy server is an Internet server that generally acts as a mediator between the client computer system and other servers hosting webpages. The proxy server can, for example, sit on a firewall and protect the client systems from unauthorized access via the Internet. In addition, the proxy can intercept and selectively block webpage requests coming from users within the firewall. A firewall is a software program or hardware device that filters information coming through the Internet, for example, offensive websites. The proxy server can also function as a caching server. Utilizing the proxy server's cached webpages, the proxy server will display previously accessed webpages to users without requiring outside access to the Internet, advantageously improving a network's performance. Of course, a proxy server can be used without a firewall. Because of such benefits, many users access the Internet via a proxy server.

One embodiment of the address translation software is, therefore, compatible with users who access the Internet via a proxy server. Normally, using a proxy setup, when a user sends a request for a Internet address, e.g. http://madonna.mp3, the browser sends the string “http://madonna.mp3/” directly to the IP address of the proxy. The proxy then performs the DNS server lookup for the request, retrieves the requested resource and returns the results to the user. The potential problem is the proxy server's DNS server may not be aware of the non-standard domain names and would therefore fail to resolve the request for “madonna.mp3”. To overcome this difficulty, an LSP provided by New.net, another TLD company, or otherwise, is used to enable resolution of non-ICANN compliant top-level domain names.

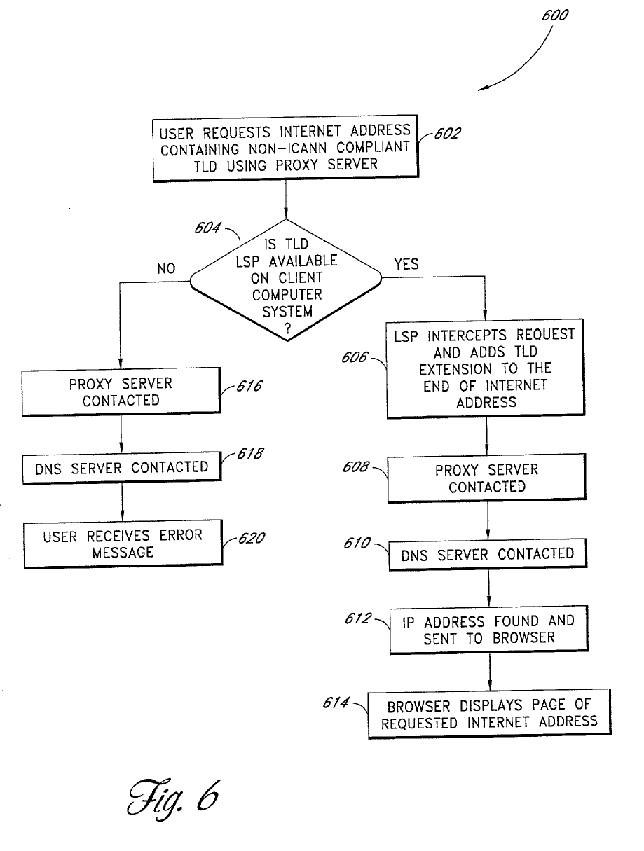

FIG. 6 illustrates a process 600 wherein a TLD LSP is utilized to detect and resolve an Internet address containing a non-ICANN compliant TLD using a proxy server. At state 602, a user enters or selects a non-ICANN compliant Internet address. At state 604, if the TLD LSP is available on the client computer system, then the TLD LSP intercepts the non-ICANN compliant Internet address. If the non-ICANN compliant TLD is listed within the TLD LSP then the TLD LSP adds a valid extension, such as “.new.net”, to the end of the Internet address at state 606. In one embodiment, the TLD LSP periodically contacts a host server to update the list of non-ICANN compliant TLDs.

The modified Internet address is then transmitted to the proxy server at state 608. The proxy server, in turn, contacts the DNS server at state 610. Due to the addition of the valid extension, the corresponding IP address is located and returned to the browser at state 612. Once the browser receives the IP address, at state 614 the browser displays the URL or Internet address requested.

If the TLD LSP is not available on the client computer system, then the non-ICANN compliant Internet address is transmitted to the proxy server at state 616. The proxy server, in turn, contacts the DNS server at state 618. Since the Internet address was not modified, a valid IP address is not found and an error message is returned to the browser at state 620.

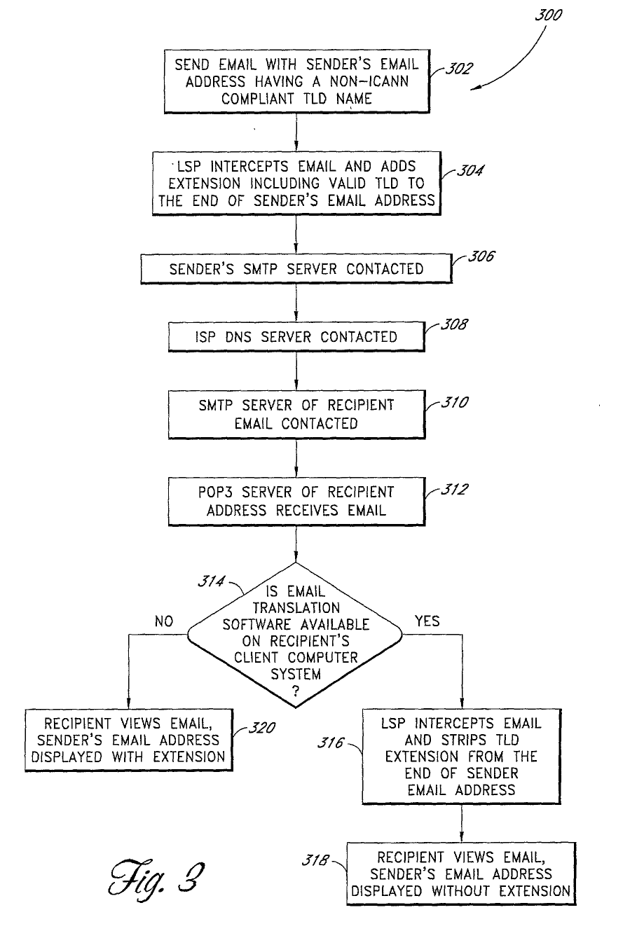

FIG. 3 illustrates an example process 300, wherein an email translation software, utilizing an LSP, processes the sending and receiving of email messages having email address with non-ICANN compliant TLDs. In particular, the process 300 processes a sender's email address which includes a non-ICANN compliant TLD contained within the sender's email address. The email translation software, including, in one embodiment, a TLD LSP, is installed on a user's client computer, as similarly described above with respect to the address translation software. The TLD LSP, while monitoring socket traffic, determines that the user has sent an email with the user's address ending in one of the non-ICANN compliant TLDs, such as, for example joe@idealab.inc. The email translation software, including the TLD LSP, intercepts the email message address and appends an extension, such as “.new.net”, having a standard TLD to the end of the address at state 304 thus, in this example, creating joe@idealab.inc.new.net. A Simple Mail Transfer Protocol (SMTP) server is contacted at state 306 which in turn contacts the sender's ISP DNS server at state 308.

At state 310, the ISP DNS server locates an MX record (Mail Exchange Record) for the domain name and an IP address. The Mail Exchange (MX) record specifies where the mail for a domain name should be delivered. If the recipient's email address is valid, then a corresponding IP address is found. The email is then transferred for delivery via a server used to store email for later retrieval by a client email application. For example, a POP server using POP3 (Post Office Protocol 3), IMAP (Internet Message Access Protocol) or the like may be used to deliver the email to the recipient's client computer and client email application at state 312. At state 314, if the email translation software is available on the recipient's client computer system, then the sender's email address is intercepted and the previously appended ICANN compliant TLD extension, “.new.net” in this example, is stripped by a corresponding TLD LSP from the sender's email address at state 316. Thus, the original address, joe@idealab.inc in this example, is reproduced. The TLD LSP can be configured to only strip predetermined or specified ICANN compliant TLDs, and will not strip other TLDs. The recipient is now able to view the email with the sender's email address stripped of the previously appended extension at state 318.

If the recipient's client computer system does not have the email translation software, then the email arrives at the recipient's client computer in the same manner as above. However, in this instance, the email is not intercepted on the receiver side, and therefore the recipient views the email at state 320 with the sender's address having the appended extension attached, and will appear, in this example, as joe@idealab.inc.new.net.

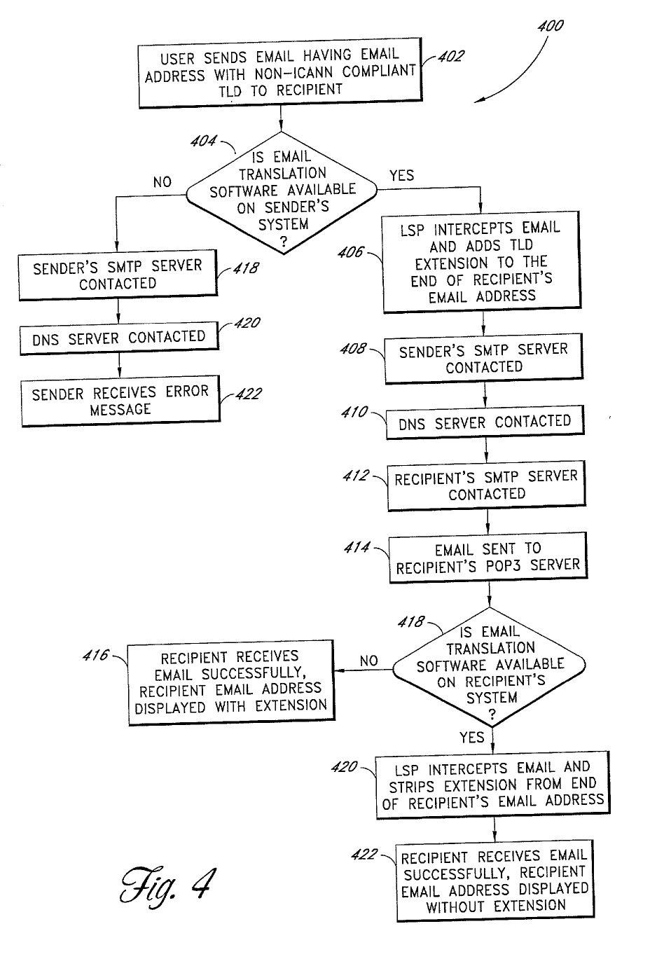

FIG. 4 illustrates a process 400 in accordance with one embodiment of the present invention, wherein a sender submits an email to a recipient having an email address containing a non-ICANN compliant TLD name at state 402 . For example, a user having an email address name@yahoo.com sends an email to a second user having an email address joe@idealab.inc. The sender's SMTP server is contacted by the host email client, which submits the recipient's address and the email message to the SMTP. If the sender's client computer system has the email translation software, at state 404, then the email is intercepted by the LSP before reaching the SMTP server. An extension including a valid TLD, such as “.new.net”, is then added to the end of the recipient email address at state 406 and then sent to the SMTP server at state 408. In turn, the SMTP server contacts the ISP DNS server requesting an MX record and a corresponding IP address at state 410. Once the IP address is found, the sender's email is transmitted to the recipient's SMTP server at state 412, where the email is then appended to the recipient's mail file, where it can later be accessed by the recipient's POP3 server at state 414 for delivery to the recipient's email client. The recipient's POP3 server delivers the email message to the recipient successfully at state 416. Optionally, the added TLD is stripped of the recipient's address for display purposes.

If the email translation software is not available on the sender's client computer system, the sender's SMTP server is contacted, without the TLD LSP intercepting, and the recipient's email address and message is submitted at state 418. The sender's SMTP server contacts the DNS server at state 420, requesting a corresponding IP address, associated with the recipient's SMTP server, for the recipient's email address. At this time, the DNS server returns a “Not Found” error message at state 422 indicating there was no corresponding IP address for the email address containing the non-ICANN compliant TLD. The error message is delivered by the SMTP server to the email's return address, and the sender retrieves the error message via the sender's POP/IMAP server.

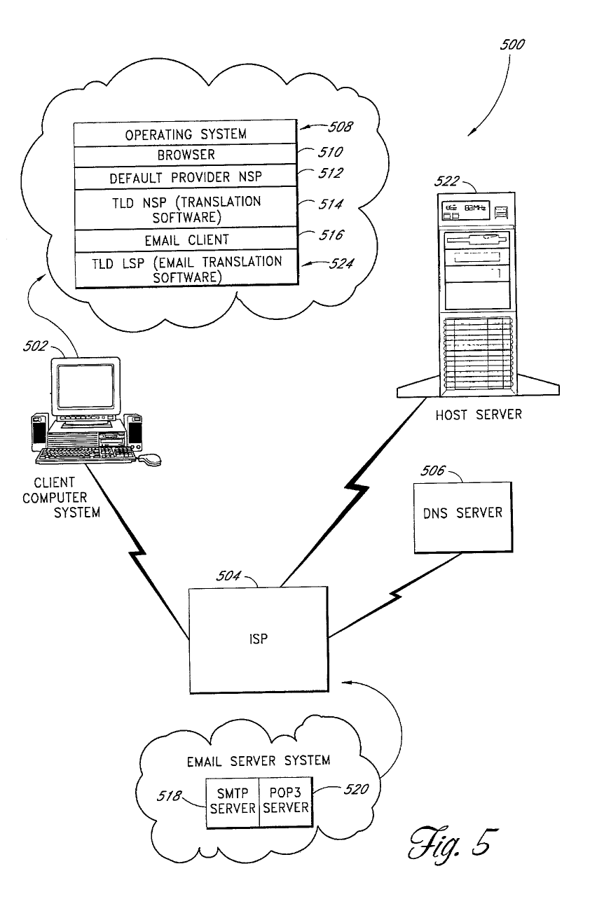

FIG. 5 illustrates an overview of a network architecture 500 which can be used with an embodiment of the present invention. The network architecture includes a host server 522, a client computer system 502, an Internet Service Provider 504, and a domain name system server 506. The client 502 can be a personal computer, personal digital assistant, interactive networked television, networked phone, or other terminal with Internet access. The client computer system 502 contains an operating system 508, a browser 510, a default provider NSP within Winsock2 512, a TLD NSP 514, an email client 516, which can be, by way of example, Microsoft Outlook, Outlook Express, Eudora or Pegasus, and a TLD LSP 524. These items take part in the process of resolving non-standard TLDs and adding a valid TLD extension. For example, as discussed above with reference to FIGS. 1-4, and 6, the extension “.new.net” or other standard TLD extension is appended to an Internet or email address.

As similarly discussed above, communication is established with the user's ISP 504 for initial requests of IP addresses for Internet addresses or email addresses using non-ICANN compliant TLDs. The ISP 504 then contacts the DNS server 506 to perform a complete lookup for the corresponding IP addresses. For sending and receiving of emails, an email server system operated by the ISP 504, includes an SMTP server 518 and a POP3 server 520. The ISP 504, specifically the SMTP server 518 within the email server, also communicates with the DNS server 506 to locate a corresponding IP address for the recipient's email address.

In another embodiment, as discussed previously with respect to FIG. 1, the non-ICANN compliant TLD are resolved by the user's ISP. Doing so advantageously makes the use of a non-ICANN TLD appear seamless to the consumer. The user first enters the Internet address with the non-ICANN compliant TLD in the browser. The browser then submits a request to the ISP's domain name system server for a corresponding IP address. Since the non-ICANN compliant TLD is registered with the user's ISP, the domain name system server can find a corresponding IP address for the requested Internet address. Once found, the IP address is transmitted to the web browser. The web browser then utilizes the IP address to connect to and display the Internet address requested. Similarly, just as the non-ICANN compliant TLDs are translatable via the ISPs lookup and DNS server system, so are the email addresses containing the non-ICANN compliant TLD names. One difficulty with this approach is obtaining the cooperation of ISPs in registering the non-ICANN compliant TLD names.

Thus, as described above, various embodiments of the present invention advantageously provide systems and methods for intercepting and translating Internet addresses containing non-ICANN compliant TLDs to valid, ICANN compliant Internet addresses. Further, systems and methods for translating Internet addresses containing non-ICANN compliant TLDs using a proxy server are provided. In addition, systems and methods are provided for translating email addresses containing non-ICANN compliant TLDs.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

What is claimed is:

1. A method of accessing network resources using an Internet address having a non-ICANN compliant top-level domain (TLD) name, the method comprising:
receiving from a user's client terminal data corresponding to a first Internet address utilizing only RFC 1035 compliant characters, the first Internet address including a non-ICANN compliant TLD, at a user's Internet Service Provider's (ISP) domain name system server (DNS server);
receiving at the user's client terminal a negative response from the ISP DNS server in response to receiving the data corresponding to the first Internet address;
receiving the first Internet address at an address converter system executing on the user's client terminal, wherein the address converter system appends an extension, including at least an ICANN compliant TLD, to the first Internet address, thereby creating a second Internet address;
submitting the second address to the ISP DNS server to locate a corresponding IP (Internet Protocol) address;
providing the corresponding IP address to a user browser; and
connecting the user browser to a system corresponding to the IP address.

2. The method as defined in claim 1, further comprising:
receiving the first Internet address using an application program interface; and
communicating the first Internet address from the application program interface to a first name space provider and a second name space provider.

3. The method as defined in claim 1, further comprising:
communicating the first Internet address to a first name space provider;
attempting to look up the first Internet address using the first name space provider, wherein the DNS server's negative response is received as a result of the lookup attempt;
communicating the first Internet address to a second name space provider, wherein the second name space provider performs the act of appending the ICANN compliant TLD to the first Internet address to create the second Internet address;
transmitting a first response, indicating the second Internet address cannot be resolved, from the second name space provider; and
communicating the second Internet address to the first name space provider, wherein the first name space provider performs the act of submitting the second address to the ISP DNS.

4. The method as defined in claim 1, wherein the address converter system includes a Layered Service Provider (LSP) configured to filter Internet addresses containing non-ICANN compliant TLDs.

5. The method as defined in claim 1, wherein ICANN compliant TLD names include .com, net, org, .gov, .edu, mil, .arpa, int, .biz, .info, name, .pro, .aero, museum, coop, and two lettered country codes.

6. A system for accessing network resources using resource addresses in a networked environment which requires the resource addresses to have a top-level domain (TLD) name compliant with a first standard, the system comprising:
a first instruction configured to determine whether a first RFC 1035 compliant address has a non-standard TLD belonging to a first set of non-standard TLD names;
a second instruction configured to append an extension, including at least a standard TLD, to the first RFC 1035 compliant address at least partly in response to the first instruction determining that the first address has a non-standard TLD belonging to the first set of non-standard TLD names; and
a third instruction configured to provide the first address with the appended standard TLD to a service that will convert the first address with the appended standard TLD into an IP address.

7. The system as defined in claim 6, further comprising a first name space provider and a second name space provider, wherein the first name space provider is used to resolve addresses having standard TLD names and the second name space provider is used to resolve addresses having non-standard TLD names.

8. The system as defined in claim 6, further comprising a windows socket layer that supports the first and second name space providers and interfaces a browser thereto.

9. The system as defined in claim 6, further comprising a fourth instruction configured to provide data corresponding to the first address with the appended standard TLD to a proxy server, so that the proxy server will provide the data corresponding to the first address with the appended standard TLD to a domain name system server for resolution.

10. The system as defined in claim 6, wherein the first instruction and the second instruction are included in a program embedded in a webpage.

11. The system as defined in claim 6, wherein the first instruction and the second instruction are included in a program downloadable from a webpage.

12. The system as defined in claim 6, wherein the first instruction and the second instruction are included in a program stored on machine readable storage media.

13. A method of accessing network resources using an Internet address having a non-standard top-level domain (TLD), the method comprising:
providing to a client system a Layered Service Provider (LSP) configured to filter Internet addresses containing non-standard TLDs and to append a corresponding extension, including at least a standard TLD, thereto;
receiving at the LSP a first Internet address having a non-standard TLD, wherein the LSP determines that the first Internet address's non-standard TLD is in a first set of non-standard TLDs;
upon determining that the first Internet address's non-standard TLD is in the first set of non-standard TLDs, adding an extension, including at least a predetermined standard TLD, to the first Internet address to create a modified first Internet address; and
providing data corresponding to the modified first Internet address to a proxy server, so that the proxy server can provide the modified first Internet address to a domain name system server.

14. The method as defined in claim 13, further comprising updating the first set of non-standard TLDs.

15. The method as defined in claim 13, wherein the LSP detects the nonstandard TLD in one of an HTTP and a proxy application level protocol, and modifies the Internet address contained in an appropriate protocol header.

16. A method of processing email addresses having non-standard top-level domain names, the method comprising:
using a Layered Service Provider (LSP) to intercept, on a sender's client system, email having a first recipient email address with a non-standard TLD;
adding, via the LSP, an extension, the extension including a standard TLD, to the recipient's first email address to generate a modified recipient email address;
submitting the modified recipient email address to the sender's SMTP server;
contacting a DNS (domain name system) server to locate a corresponding IP address for an email server system associated with the modified recipient email address;
returning the corresponding IP address to the sender's SMTP server;
submitting the email to the email server system for delivery to the recipient using the corresponding IP address; and
providing the email to the recipient.

17. The method as defined in claim 16, wherein the act of submitting the email to the email server system for delivery to the recipient further comprises appending the email to an email file associated with the recipient.

18. The method as defined in claim 16, wherein the email is provided to the recipient via an email client host on a client computer.

19. The method as defined in claim 16, wherein the email is provided to the recipient via a web-based email system.

20. The method as defined in claim 16, wherein the email server system includes an SMTP server and a POP server.

21. The method as defined in claim 16, wherein the LSP is installed on top of a default Transport Service Provider (TSP).

22. A method of processing email addresses having non-ICANN compliant level domain (TLD) names, the method comprising:
determining on a sender's client system whether a first email address for an email being dispatched by the sender contains a non-ICANN compliant TLD name, wherein the first email address is associated with an intended email recipient;
appending at least an ICANN compliant TLD to the first email address at least partly in response to determining that the email address contains a non-ICANN compliant TLD name, thereby forming a second email address;
submitting the second email address to a domain name system server (DNS server) via an SMTP server to locate an IP address corresponding to a server associated with the second email address;
locating the IP address; and
using the located IP address to transmit the email so that it can be accessed by the recipient.

23. The method as defined in claim 22, further comprising:
receiving the email and the second email address on the recipient's client system;
automatically removing at least the ICANN compliant TLD from the end of the second email address to recreate the first email address; and
presenting the email in conjunction with the first email address to the recipient.

24. The method as defined in claim 22, further comprising utilizing a Layered Service Provider (LSP) to filter email addresses containing non-ICANN compliant TLD names and to append at least corresponding ICANN compliant TLD names thereto.

25. The method as defined in claim 22, transmitting the email and data corresponding to the second email address to a proxy server associated with the sender's client system.

26. The method as defined in claim 22, wherein the mail server includes a Simple Mail Transfer Protocol (SMTP) server.

27. The method as defined in claim 22, wherein the server associated with the second email address includes an SMTP server and a Post Office Protocol (POP) server.

28. A system for processing an email address having a non-ICANN compliant level domain (TLD) name, the method comprising:
a first instruction configured to determine whether a first email address for an email being dispatched by a sender contains a non-ICANN compliant TLD name, wherein the first email address is associated with an intended email recipient;
a second instruction configured to form a second email address by appending an extension including at least an ICANN compliant TLD name to the first email address at least partly in response to a determination by the first instruction that the first email address contains a non-ICANN compliant TLD name; and
a third instruction configured to provide the second email address so that the second email address can be submitted to a domain name system server (DNS server) via a server system to thereby locate a corresponding IP address.

29. The system as defined in claim 28, wherein the first instruction is included in a Layered Service Provider (LSP).

30. The system as defined in claim 28, further comprising a fourth instruction configured to remove the appended extension.

31. A system for processing an email address having a non-ICANN compliant top-level domain (TLD) name, the system comprising:
a first instruction configured to determine whether a first email address for a first received email contains a predetermined domain; and
a second instruction configured to form a second email address by removing for display the predetermined domain.

32. The system as defined in claim 28, wherein the first instruction is included in a Layered Service Provider.

33. The system as defined in claim 28, further comprising a third instruction configured to display the second email address to a user.

34. The system as defined in claim 28, wherein the domain had been appended by a sender client system.

35. A method of accessing network resources, the method comprising:
using a Layered Service Provider (LSP) to identify a first Internet address having a non-standard TLD, wherein the LSP determines that the first Internet address's non-standard TLD is in a first set of non-standard TLDs; and
adding an extension, including at least a predetermined standard TLD, to the first Internet address to create a modified first Internet address.
